(19) United States
(12) Patent Application Publication
(10) Pub. No.: US 2022/0405721 A1
(43) Pub. Date: Dec. 22, 2022

(54) ALLOCATION OF SPLIT TENDER TRANSACTIONS

(71) Applicant: Walmart Apollo, LLC, Bentonville, AR (US)

(72) Inventors: Parivesh Gupta, Jersey City, NJ (US); Atsushi Miyamoto, Fremont, CA (US); Cena A. Crane, Brooklyn, NY (US); Ruchir Choudhry, San Ramon, CA (US); Kumaraguru Vijayakumar, Dublin, CA (US); Madhav V. Deverkonda, San Ramon, CA (US)

(21) Appl. No.: 17/845,819

(22) Filed: Jun. 21, 2022

Related U.S. Application Data
(60) Provisional application No. 63/287,752, filed on Dec. 9, 2021.
(60) Provisional application No. 63/213,171, filed on Jun. 21, 2021.

(51) Int. Cl. G06Q 20/08; G06Q 30/06

(52) U.S. Cl. CPC G06Q 20/085; G06Q 30/0635

(57) ABSTRACT

In some embodiments, systems, apparatuses and methods are provided herein useful to provide charge allocation for split tender transactions. In some embodiments, a system includes a payment rules database, a product database, a customer database, a network interface, and a control circuit. In some embodiments, the control circuit: retrieves payment instruments associated with a customer account; retrieves eligibility rules associated with the payment instruments; receives a list of products for purchase; determines an allocation order for the payment instruments; determines a charge allocation between the payment instruments; causes the charge allocation to be displayed via a user payment user interface on a user device; and processes a transaction using two or more of the payment instruments based on the charge allocation.

### CROSS-REFERENCE TO RELATED APPLICATION(S)

This application claims the benefit of U.S. Provisional Application No. 63/213,171 filed Jun. 21, 2021, and U.S. Provisional Application No. 63/287,752 filed Dec. 9, 2021, both of which are incorporated herein by reference in their entirety.

### TECHNICAL FIELD

This invention relates generally to digital wallets and particularly to providing user interfaces for split tender digital wallet transactions.

### BACKGROUND

In retail transactions, consumers can add items to be purchased to a cart for payment and then select between various payment options in a digital wallet to complete the purchase. For example, a consumer may be able to select and use a credit card or gift card to complete the payment. Some payment systems also allow the consumer to split payment between multiple payment options.

### BRIEF DESCRIPTION OF THE DRAWINGS

Disclosed herein are embodiments of systems and methods for providing charge allocation for split tender transactions. This description includes drawings, wherein:

FIG. 1 comprises a block diagram of a system in accordance with some embodiments;

FIG. 2 comprises a flow diagram of a process in accordance with some embodiments.

FIG. 3 comprises a block diagram of a system in accordance with some embodiments;

FIG. 4 comprises a flow diagram of a process in accordance with some embodiments;

FIGS. 5A-5C comprises illustrations of a user interface for digital wallet payment in accordance with some embodiments;

FIGS. 6A-6J comprises illustrations of a user interface for allocation of split tender transactions in accordance with some embodiments;

FIGS. 7A-7D comprises illustrations of a user interface for digital wallet payment in accordance with some embodiments;

FIGS. 8A-8C comprises illustrations of user interfaces for digital wallet payment instrument management in accordance with some embodiments; and

FIGS. 9A-9B comprises illustrations of user interfaces for digital wallet payment in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, pursuant to various embodiments, systems, devices, and methods are provided for a checkout terminal for automatic charge allocation for split tender transactions. In some embodiments, a system for automatic charge allocation comprises a payment rules database storing eligibility rules associated with a plurality of payment methods, a product database storing product characteristics associated with a plurality of products, a customer database, a network interface configured to receive data from a user device, and a control circuit coupled to the payment rules database, the product database, the customer database, and the network interface. The control circuit being configured to retrieve a plurality of payment instruments associated with a customer account from the customer database, wherein the plurality of payment instruments includes payment instruments of two or more payment method types, retrieve eligibility rules associated with each of the plurality of payment instruments from the payment rules database, determine an allocation order for the plurality of payment instruments, receive, via the network interface, a list of products for purchase, determine a charge allocation between the plurality of payment instruments based on the allocation order, eligibility rules associated with each of the plurality of payment instruments, and characteristics of products in the list of products for purchase retrieved from the product database, cause, via the network interface, the charge allocation to be displayed via a user payment user interface on the user device, and process a transaction for the list of products using two or more of the plurality of payment instruments based on the charge allocation.

Conventionally, most mobile wallets allow only one payment method to be selected as the default payment method for a transaction. Split tender retail payments can get complicated especially when some of the payment methods have different APL (Approved Product Lists) and eligibility. In some embodiments, systems and methods described herein add split tender capability to mobile wallets by utilizing stored eligibility rules associated with different payment methods and instruments. In some embodiments, the systems and methods described herein reduce friction during placing an order (by recommending allocations against available payment methods), allow for one-click order placement, and remove the burden of matching payment instruments with eligible products during checkout. In some embodiments, the rules-based allocation logic would charge the most restrictive payment method first while considering basket payment method eligibility. In some embodiments, the system compares the basket, determines eligibility, and performs allocations. In some embodiments, this system supports online, mobile, and in-store checkouts. Smart allocation generally refers to a suggested allocation of available customer funds by considering payment method eligibility for the items in the customer's basket allowing customers to split their order total between multiple types of payment methods (e.g. Credit Cards, Gift Cards, EBT online, and Benefit Cards). In some embodiments, automatic split tender allocation may further include customer preferences and a learning model based on a customer's past transaction behavior.

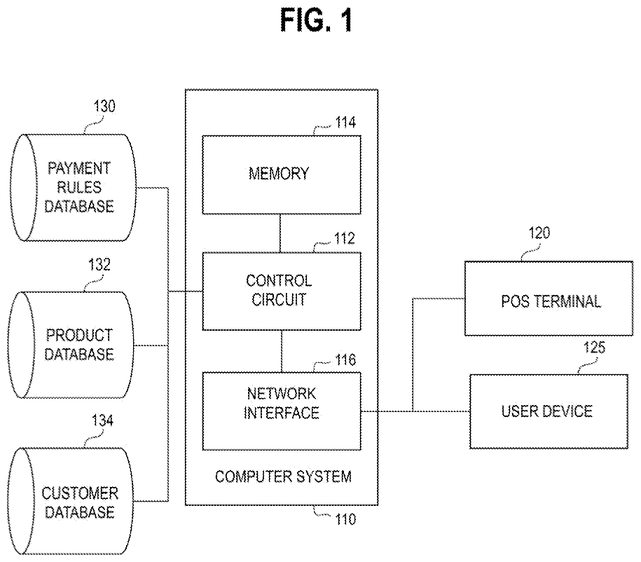

Referring now to FIG. 1, a system for charge allocation for split tender transactions is shown. The computer system 110 is coupled to a payment rules database 130, a product database 132, a customer database 134, a user device 125, and a point of sale (POS) terminal 120.

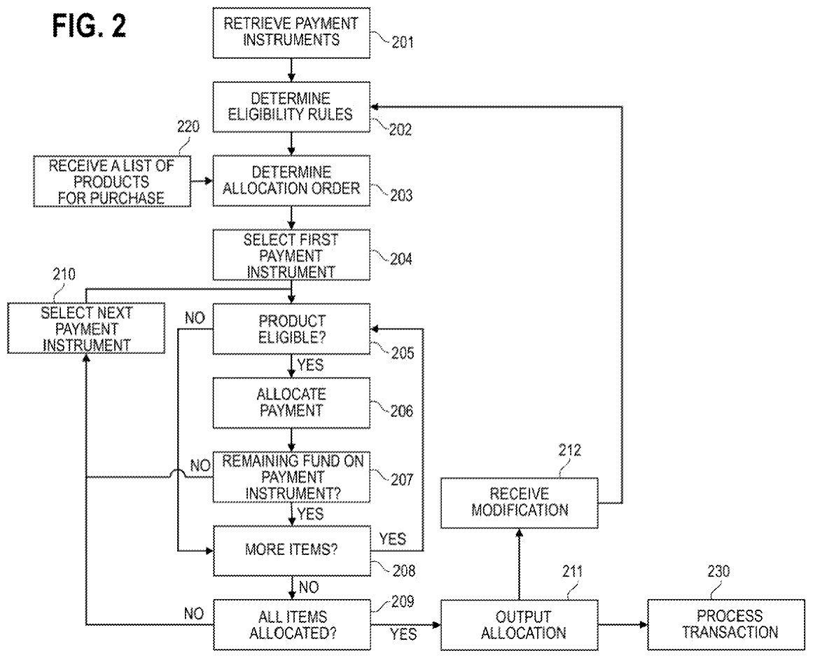

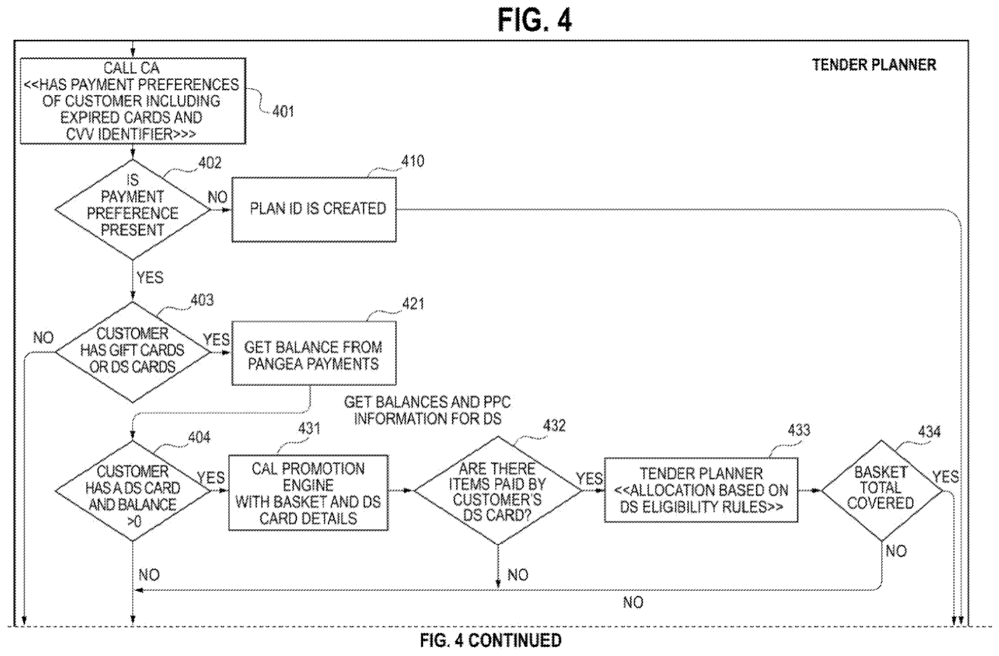

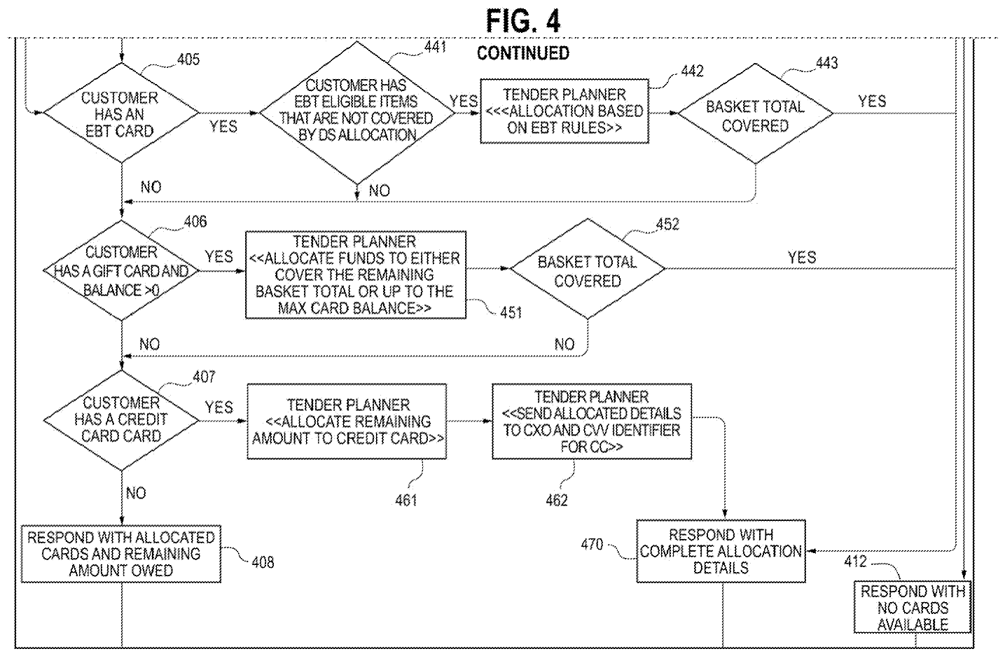

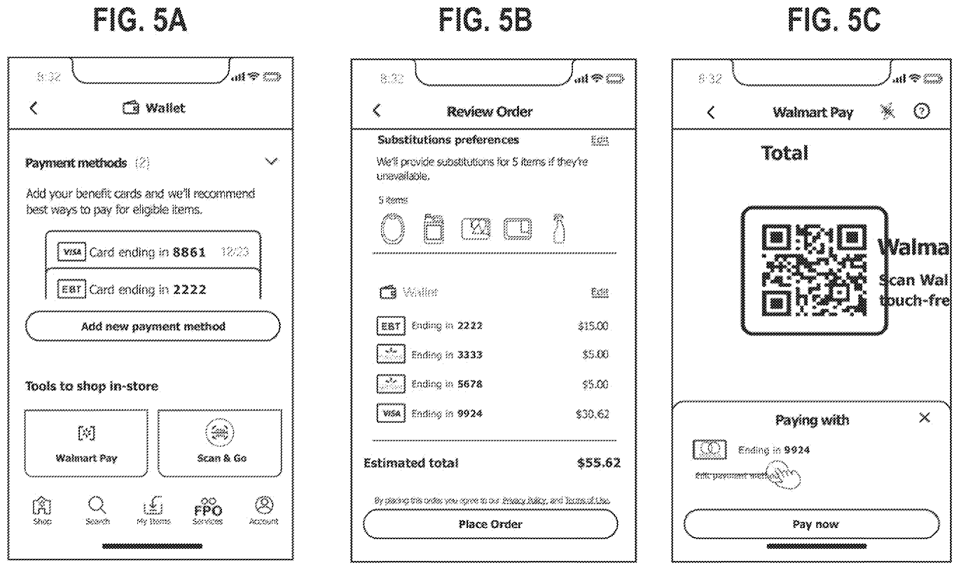

The computer system 110 comprises a control circuit 112, a memory 114, and a network interface device 116. The computer system 110 may comprise one or more of a server, a retailer backend system, a central computing system, a desktop computer system, and the like. The control circuit 112 may comprise a processor, a microprocessor, a central processing unit (CPU), a graphics processing unit (GPU), an application-specific integrated circuit (ASIC), and the like and may be configured to execute computer-readable instructions stored on a computer-readable storage memory 114. The computer-readable storage memory 114 may comprise volatile and/or non-volatile memory and have stored upon it, a set of computer-readable instructions which, when executed by the control circuit 112, causes the computer system 110 to determine charge allocation for a transaction initiated at a POS terminal 120 and/or a user device 125 based on information stored in the payment rules database 130, the product database 132, and the customer database 134. In some embodiments, the computer-executable instructions may cause the control circuit 112 of the computer system 110 to perform one or more steps described with reference to FIG. 2 and FIG. 4 herein. In some embodiments, the computer-executable instructions may cause the control circuit 112 of the computer system 110 to provide a user interface for viewing and interacting with stored payment methods, such as the graphical user interfaces described with reference to FIGS. 5A-5C, 6A-6J, 7A-7D, 8A-8C, and 9A-9B. In some embodiments, the memory 114 may further store one or more of the payment rules database 130, the product database 132, and the customer database 134.

The network interface device 116 may comprise a data port, a wired or wireless network adapter, and the like. In some embodiments, the computer system 110 may communicate with the user device 125 and/or the POS terminal 120 over a network such as a local network, a private network, or the Internet. In some embodiments, the user device 125 may be a processor-based standalone user device such as a personal computer, a desktop computer, a laptop computer, a mobile device, a smartphone, and the like. The user device 125 may comprise user input/output devices such as a keyboard, a mouse, a touch screen, a display screen, a VR/AR display device, a speaker, a microphone, etc. The user device 125 may execute an application for displaying an e-commerce or digital wallet graphical user interface for interacting with stored payment methods and charge allocation determination provided by the computer system 110. For example, the user device 125 may comprise a mobile phone running an e-commerce or digital wallet application or a computer accessing a website. A user may use the user device 125 to add, modify, and remove payment methods and instruments associated with the customer's profile stored in the customer database 134. In some embodiments, the computer system 110 may further provide an e-commerce application or website for the user to scan and/or select products for purchase. In some embodiments, the application may allow the user to scan barcodes on physical products and/or select products from an online catalog to add to a virtual cart and provide automatic charge allocation during the checkout of the virtual cart. In some embodiments, the user interface may allow the user to select and de-select individual payment instruments and/or payment method types stored in the customer database 134 for payment allocation. Examples of user interfaces that may be provided from the computer system 110 via the user device 125 are described with reference to FIGS. 5A-5C, 6A-6J, 7A-7D, 8A-7C, and 9A-9B.

The POS terminal 120 may comprise an in-store checkout terminal for processing purchase transactions. In some embodiments, the POS terminal 120 may comprise a clerk-operated or customer self-service POS system. The POS terminal 120 may comprise one or more of an optical scanner, an optical camera, a conveyor system, a card reader, a display screen, etc. In some embodiments, the POS terminal 120 may comprise conventional components of a checkout terminal. In some embodiments, the POS terminal 120 may be configured to identify items brought to the terminal by the customer to initiate a purchase transaction. In some embodiments, the POS terminal 120 may further be configured to provide a POS or transaction identifier to the user device 125 by displaying an image (e.g. QR code, barcode) or transmitting a wireless signal, such that the user device 125 may link the transaction with the customer profile by transmitting the POS identifier to the computer system 110 along with a user account identifier. In some embodiments, the user device 125 may provide a user account identifier by displaying an image for scanning by the POS or transmitting a wireless signal, the POS terminal 120 may transmit the user accounts identifier to the computer system 110 to link the user account with the transaction occurring at the POS terminal 120. In some embodiments, the POS terminal 120 may provide the scanned item information to the computer system 110 for charge allocation and payment processing. In some embodiments, the POS terminal 120 may be configured to display the automatic charge allocation to the customer via a display screen, and the customer may choose to accept or modify the charge allocation determined by the computer system 110. In some embodiments, the user device 125 may perform the functions of the POS terminal 120 and the POS terminal 120 may be omitted. For example, a customer may use the user device 125 or another auxiliary device to capture item identifiers from in-store items and complete a transaction using automatic charge allocation. In some embodiments, for online purchases, the POS terminal 120 may be omitted.

The payment rules database 130 comprises a computer-readable memory storage storing payment eligibility rules associated with a plurality of payment instruments and/or payment method types. As used herein, a payment instrument generally refers to an instrument having a unique payment instrument identifier (e.g. credit card number, debit card number, gift card number, benefits program account number, directed spend account number, etc.). A payment method type generally refers to a category of payment methods such as charge card (e.g. credit and debit card), gift card, benefits card (e.g. EBT, FSA), directed spend card, rewards point, etc. As used herein, a directed spend card is a gift card or charge card with customized item level controls that allows the payee to limit cardholder spending to specific categories or items. In some embodiments, the rules in the payment rules database 130 may be associated with an individual payment instrument (e.g. rules set for a specific directed spend account), a group of payment instruments within a payment method type (e.g. benefits card under the same benefits program), or a payment method type (e.g. gift card purchases). In some embodiments, eligibility rules may comprise one or more of included products, included product categories, included product characteristics, excluded products, excluded product categories, excluded product characteristics, maximum per-item cost, maximum total cost, maximum per-period spending, etc. For example, rules for a group of payment instruments may exclude the purchase of alcohol and tobacco products. In another example, rules for another group of payment instruments may include only health care products.

The product database 132 comprises a computer-readable memory storage storing product information associated with products for sale. In some embodiments, the product information may comprise product characteristics such as product category, product sub-category, product price, product age restriction, product nutrition label information, product description, etc. associated with the product identifier. In some embodiments, the payment rules database 130 and the product database 132 may be combined into a single database where the eligibility for each product for each payment instrument, payment instrument group, and/or payment method type are determined and stored.

The customer database 134 comprises a computer-readable memory storage storing customer information associated with customer profiles. In some embodiments, the customer profiles may comprise customer information and stored payment instruments. In some embodiments, a customer may enter payment instruments to store with the system via a user device 125 or choose to store a payment instrument used at a POS terminal 120 to the customer profile. In some embodiments, customer database 134 may further store whether the customer has selected to include each of the stored payment instruments for automatic charge allocation. In some embodiments, the customer database 134 may store other information such as customer purchase history, customer payment preferences, etc.

In some embodiments, the computer system 110 may further be coupled to an inventory system, a payment processing system, and an order fulfillment for processing and fulfilling purchase transactions received via the POS terminal 120 and/or the user device 125.

In some embodiments, one or more of the payment rules database 130, the product database 132, and the customer database 134 may be implemented on one or more physical computer-readable memory storage devices. While one computer system 110 is shown, in some embodiments, the functionalities of the computer system 110 may be implemented on a plurality of processor devices communicating on a network. In some embodiments, the computer system 110 may be coupled to a plurality of user devices 125 and/or POS terminals 120 and simultaneously provide automatic charge allocation to a plurality of transactions involving different users at different locations.

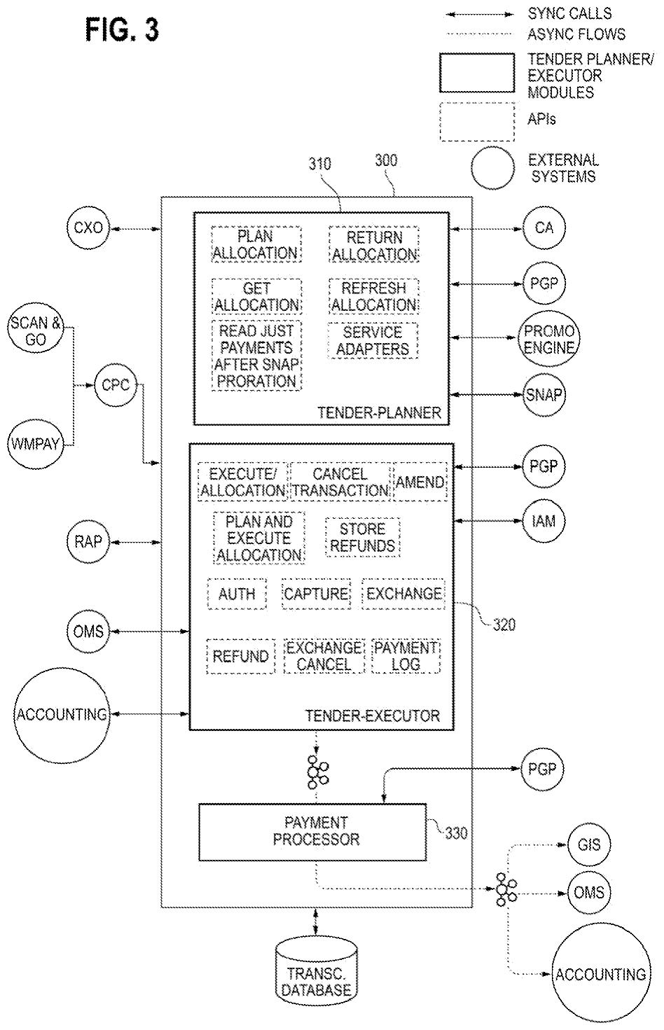

Referring now to FIG. 2, a method for providing automatic charge allocation is shown. In some embodiments, the steps shown in FIG. 2 may be performed by a processor-based device such as a control circuit executing a set of computer-readable instructions stored on a computer-readable memory. In some embodiments, one or more steps of FIG. 2 may be performed by the computer system 110 described with reference to FIG. 1, the charge allocation system 300 described with reference to FIG. 3 herein, or a similar device.

In step 201, the system retrieves a plurality of payment instruments associated with a customer account from a customer database. In some embodiments, a user may log into an e-commerce or mobile wallet application or website using a log-in credential and the payment instruments may be retrieved based on the user account credentials. In some embodiments, a user may provide a user account identifier to a POS system via entering a code, scanning a machine-readable code (e.g. barcode, QR code), and/or providing a wireless signal (e.g. NFC, Bluetooth), and the POS system may, in turn, send the user identifier to the system along with other transaction information determined at the POS to associate the user account with the transaction. In some embodiments, the payment instruments may comprise two or more payment method types. In some embodiments, the payment instruments may include two or more of credit or debit cards, gift cards, benefits cards, directed spend cards, or rewards points. In some embodiments, prior to step 201, a user may have pre-selected only a subset of all stored payment instruments for payment allocation, and step 202 may proceed with only the payment instruments selected.

In step 202, the system determines the eligibility rules associated with each of the plurality of payment instruments in a payment rules database. In some embodiments, eligibility rules for each payment method comprise one or more of included products, included product categories, included product characteristics, excluded products, excluded product categories, and excluded product characteristics. In some embodiments, two or more different payment instruments associated with a payment method type may have different eligibility rules. For example, benefits cards associated with different benefits programs may cover different eligible items. In some embodiments, eligibility rules may be associated with the payment method type (e.g. credit cards, gift cards), a subset of payment instruments within a payment method type (e.g. benefits programs), and individual payment instruments (e.g. directed spend cards).

In step 220, the system receives a list of products for purchase from a user device. In some embodiments, the list of products may be received from a user device executing an e-commerce application or accessing a website. In some embodiments, the list of products may be received from an in-store POS terminal that detected product identifiers from products a customer brought to the POS terminal.

In step 203, the system determines an allocation order for the plurality of payment instruments. In some embodiments, the allocation order is determined based on payment method types associated with each of the plurality of payment instruments. In some embodiments, the payment instruments may have a default allocation order based on system pre-set rules and/or customer preferences selection.

In step 204, the system selects the first payment instrument based on the allocation order. In step 205, the system determines whether the first item in the list of products for purchase is eligible for payment by the first payment instrument based on eligibility rules associated with the first payment instrument. For example, for an EBT card, the system may determine whether the product is eligible for payment by EBT. In some embodiments, the system also determines whether there is sufficient fund in step 206 and proceeds to step 206 only if there is sufficient fund to cover the cost of the product in full or in part. Otherwise, the process may proceed to step 210. If the product is eligible, in step 206, the cost of the product is allocated to the first payment instrument. In step 207, the system determines whether any fund remains on the payment instrument. If the payment instrument's fund has been exhausted, the system proceeds to step 210. If some fund remains, the system moves to step 208 to determine whether there are more products on the list of products. If so, the system repeats the eligibility determination in step 205 for the next item on the list. When all items have been checked for eligibility for a payment instrument, the system determines whether all item costs have been allocated in step 209. If unallocated cost remains, the system selects the next payment instrument according to the allocation order in step 210 and repeats steps 205-209 with the next payment instrument. In some embodiments, at least one payment instrument may comprise an unrestricted payment method that is eligible to pay for the cost of any product for sale. In some embodiments, when the next payment instrument is an unrestricted payment instrument, the system may allocate any remaining cost to the unrestricted payment instrument without repeating steps 210-208.

In some embodiments, for a transaction at an in-store POS, the system may use include in-person payment as an unrestricted payment method last in the allocation order. The customer may be given the option to pay for any remaining cost with cash or a payment instrument not stored in the customer profile at the in-store POS.

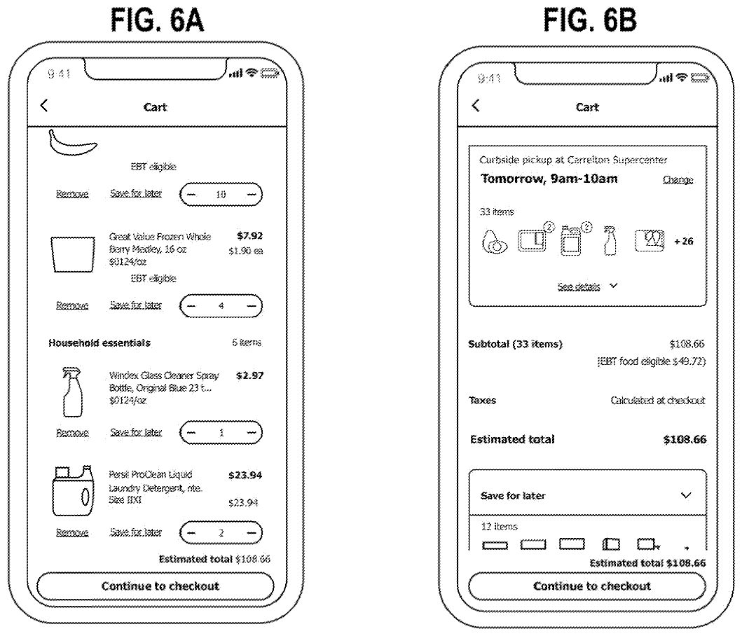

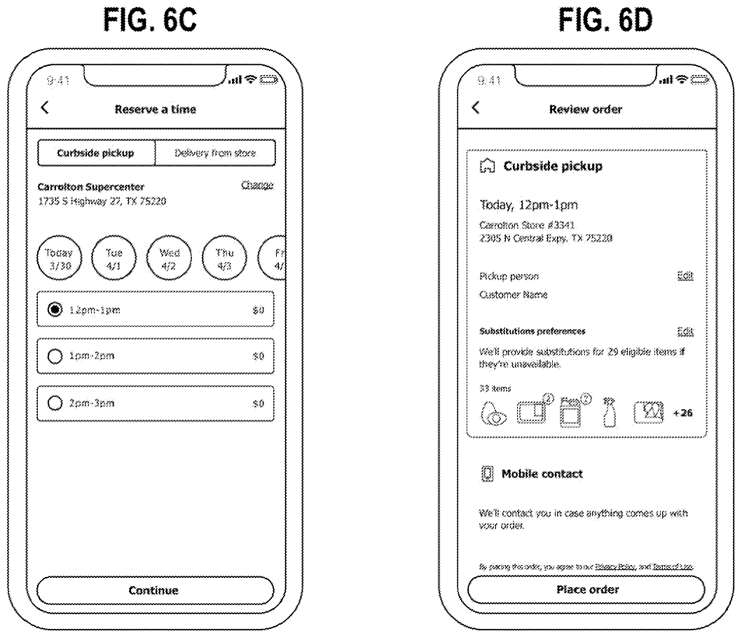

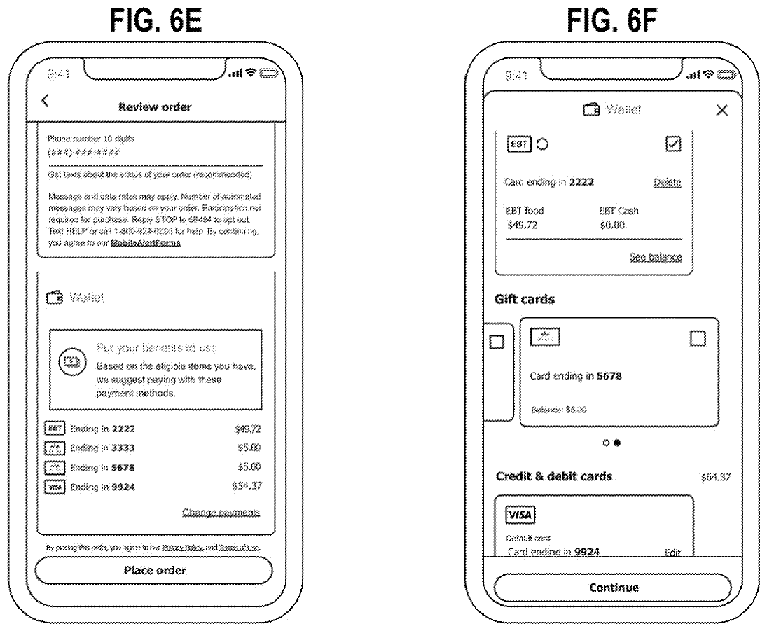

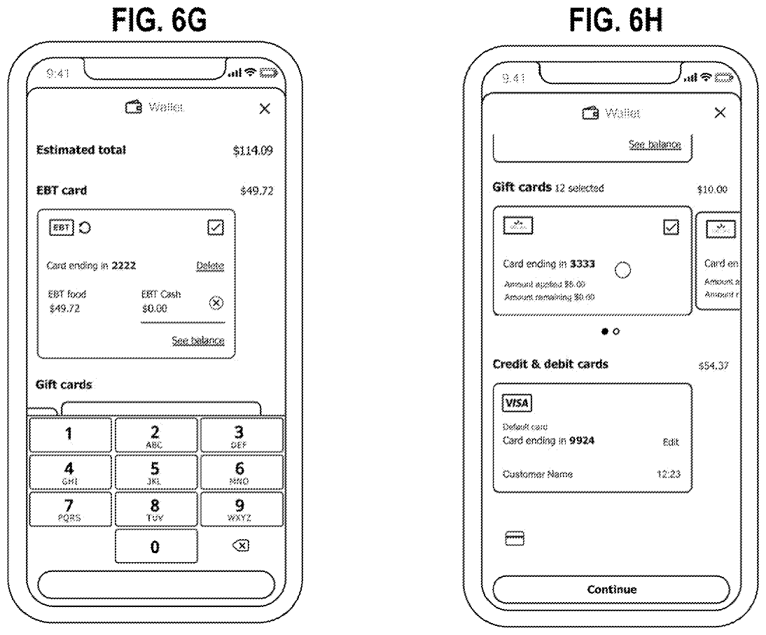

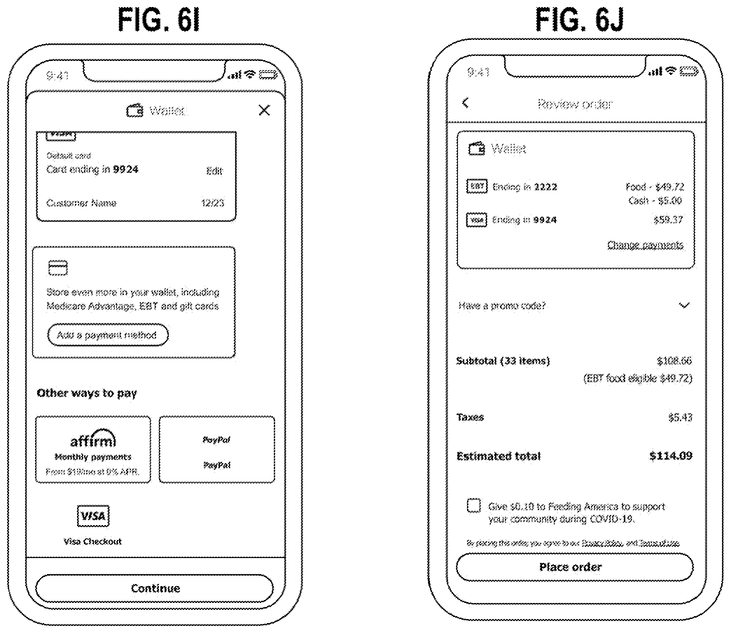

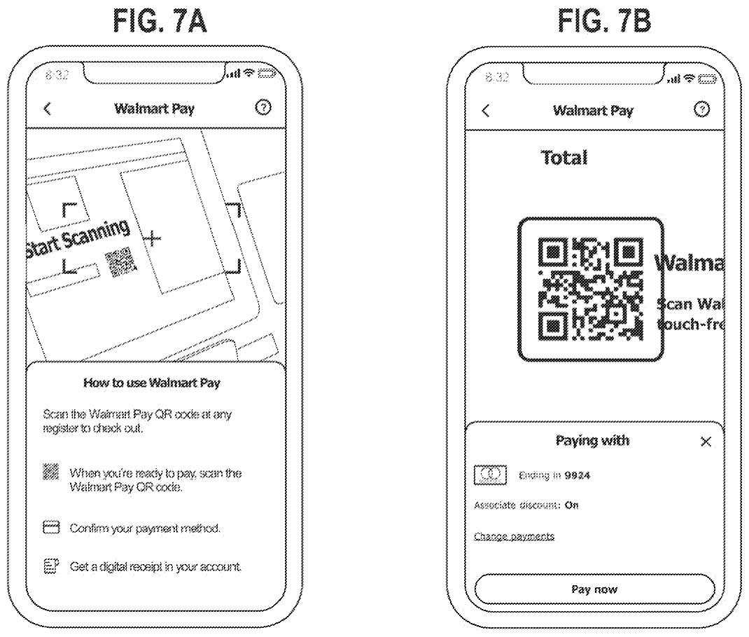

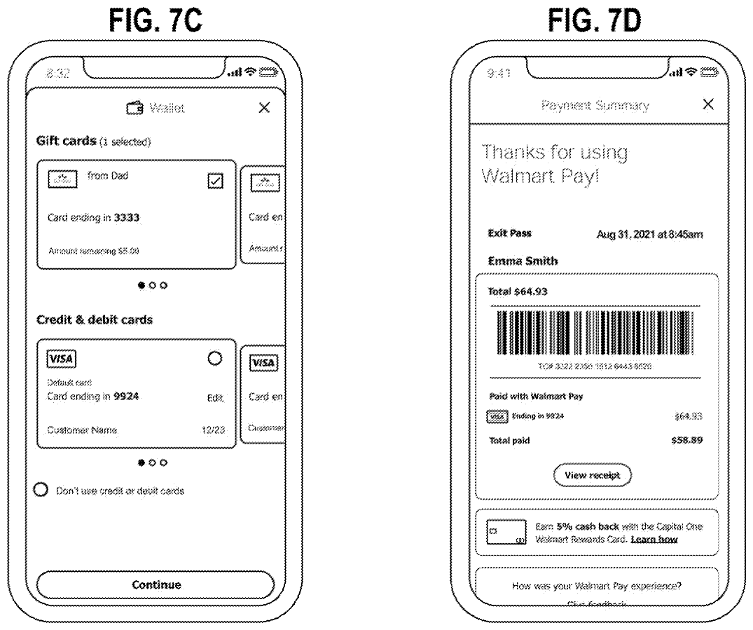

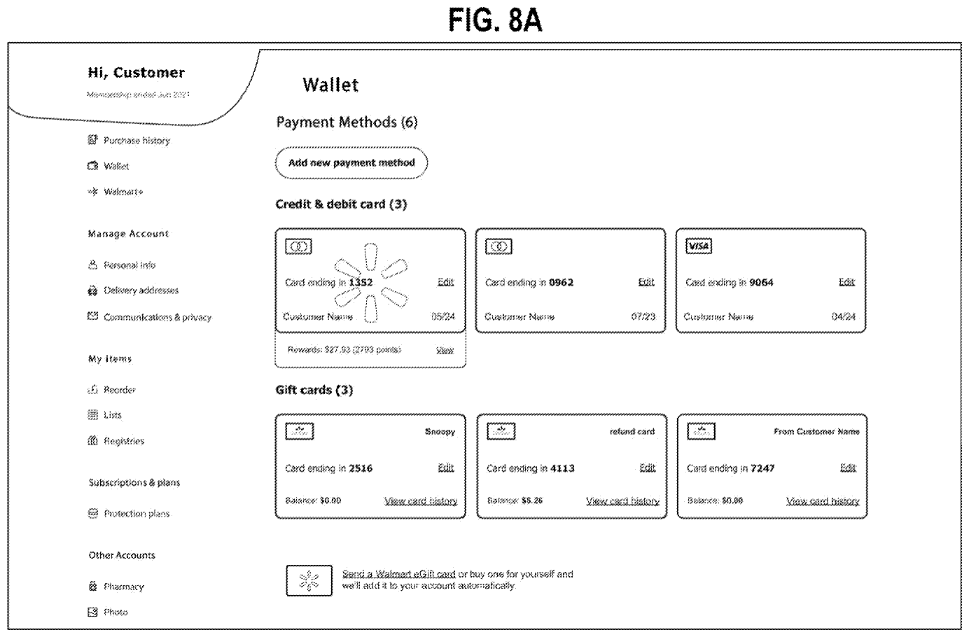

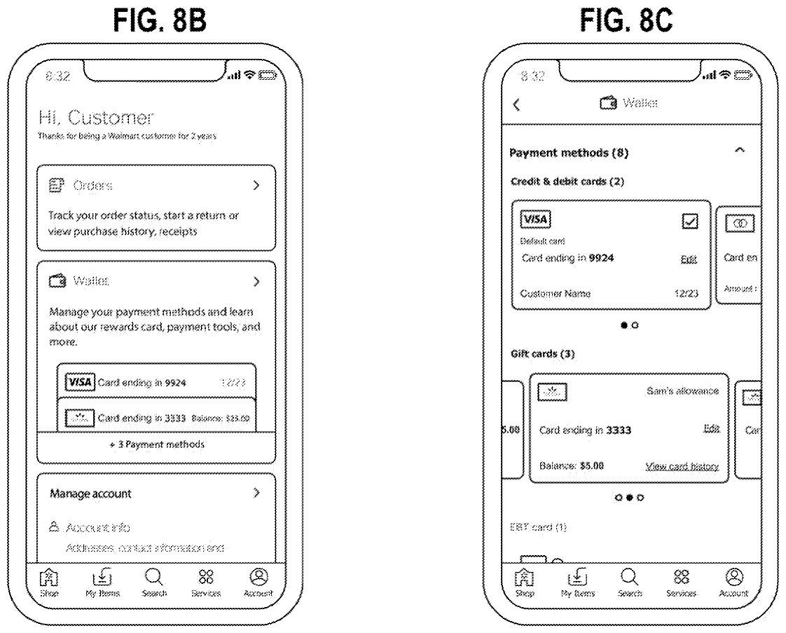

In step 209, when all cost of the items has been allocated, the system output the system suggested charge allocation in step 211. In some embodiments, the charge allocation may be displayed via the user interface that displays each allocated payment instrument and the cost allocated to each payment instrument. Examples of such user interfaces are shown in FIG. 5B and FIG. 6E. In some embodiments, after step 211, the user may be given the option to modify the allocation after the system suggested allocation is displayed. In step 212, the user may be presented with a user interface to select or deselect one or more stored payment instruments for the payment allocation determination. Examples of such user interfaces are shown in FIG. 6F, 6H, FIG. 7C, and FIG. 8A. In some embodiments, a user may also add new payment instruments to the user account in step 212. Examples of a user interface for adding a new payment instrument are shown in FIG. 5A and 6I. In some embodiments, a user may further select a charge limit for one or more of the selected payment instruments, and the charge limit may be used as the available fund limit for the payment instrument. Upon receiving the charge allocation modification, the system returns to step 202, repeats the process based on the newly selected set of payment instruments, and outputs an updated charge allocation in step 211.

After the allocation is outputted and displayed to the user, the user may choose to accept the charge allocation and proceed to process the transaction based on the charge allocation. In step 230, the system may then submit payment requests to payment processing systems associated with each of the allocated payment instruments. When payment authorization is obtained for each payment instrument, the system completes the checkout process. In some embodiments, if any of the allocated payment instruments are rejected at payment processing, the system may remove the rejected payment instrument and perform allocation determination again with the remaining payment instruments according to steps 202-211 and display the updated suggested payment allocation to the user. In some embodiments, the system may generate a physical or electronic receipt based on the processed purchase transaction. In some embodiments, the system may further send the list of products for purchase as an order to a fulfillment system for fulfillment.

Generally, the charge allocation between the plurality of payment instruments is determined based on the allocation order, eligibility rules associated with each of the plurality of payment instruments, and characteristics of products in the list of products for purchase retrieved from the product database. In some embodiments, if multiple payment instruments are of the same payment method type, the allocation of the multiple payment instruments may be determined based on maximizing the total payment allocated to all payment instruments of the payment method type. In some embodiments, the charge allocation is determined to minimize an amount allocated to an unrestrictive payment instrument such as a credit card, a debit card, or cash. In some embodiments, the system may have default rules for determining allocation order for payment instruments or groups of payment instruments within a payment method type based on the restrictiveness of eligible rules associated with the payment instruments or payment instrument groups. In some embodiments, the system may repeat steps 205-209 with payment instruments with a payment method type in different allocation orders, and select an allocation order that maximizing total payment allocated to all payment instruments of the payment method type. For example, if a customer has two benefits cards, card A and card B, the system may first determine the total cost that may be allocated to card A and card B both when card A is applied first and when card B is applied first. The system may then determine the suggested charge allocation based on the allocation order that led to the higher total cost being covered by the combination of card A and card B. In some embodiments, this process may be repeated for payment methods within multiple payment method types.

In some embodiments, a digital wallet may store information on retail store membership, insurance card, ID, eReceipts, and open orders (e.g. upcoming deliveries and pickup orders). The system may incorporate a variety of payment options such as Debit, Credit, Gift Card, EBT, SNAP, FSA, Directed Spend, and Stored Value in the allocation process. The wallet may further provide a retailer stored value account for instant refund, P2P transfers, and change roundup. In some embodiments, a digital wallet removes the need to carry a physical wallet and does not require a bank account: http://www.investopedia.com/personal-finance/banking-101/ with a physical firm or branch, allowing shoppers in underserved areas to enable a wider financial inclusion.

In some embodiments, the split payment between multiple payment methods may be based on the basket eligibility and a set of rules-driven allocation logic. The initial allocation logic may charge the most restrictive payment method first—while considering basket payment method eligibility. In some embodiments, smart allocation may include a learning model for providing allocation recommendations based on personalized customer transaction behavior. In some embodiments, automatic allocation suggestions may work in conjunction with preferences. In some embodiments, the system initially operates on a baseline set of fixed rules and the customers may opt-out of smart allocation or make changes to the default allocation. In some embodiments, the allocation recommendation is provided consistently across various checkout methods (e.g. in-store, online, mobile). In some embodiments, in case a particular tender is not supported by a particular checkout, the rules may be adjusted to not consider the payment method. The backend processes related to payment methods are associated with latency due to the service calls to get the balance (Gift Card and Directed Spends), invoke Promotion Engine to get the promotion eligibility for Directed Spends, etc. In some embodiments, the system includes default allocation rules for Directed Spends and other multiple tender types.

In some embodiments, the system allocates charges between multiple credit cards and maximizing points earned/card balances. In some embodiments, the system includes a machine learning algorithm for determining allocation based on customer preferences.

Referring now to FIG. 3, a block diagram of a system is shown. The charge allocation system 300 for providing automatic split tender allocation includes a tender planner 310, a tender executor 320, and a payment processor 330. In some embodiments, the components and modules shown in FIG. 3 may be hardware and/or software modules executed on a processor-based device executing machine-readable instructions stored on a computer-readable storage memory.

The charge allocation system 300 is generally configured to take in information from customers and/or third-party payment systems and determine a split tender recommendation for a customer transaction and process payment based on the recommendation and/or customer selection. The charge allocation system 300 is coupled to a checkout system (CXO), cloud-powered checkout (CPC), including app-based checkout (E.g. Scan & Go) and mobile wallet (e.g WMPay) systems, and a return application platform (RAP).

The tender planner 310 includes a plan allocation module, a return allocation module, a get allocation module a refresh allocation module, a readjust payments after SNAP proration module, and service adapters. The tender planner is configured to execute one or more of its modules based on communications with customer accounts (CA), a transaction system layer for payment processing (PGP), promotions engine, and benefits/assistance programs system (e.g. SNAP). In some embodiments, the tender planner 310 is configured to determine a suggested charge allocation and provide the allocation to the tender executor for execution upon acceptance by the customer. In some embodiments, the tender planner 310 is configured to perform one or more steps described with reference to FIG. 2 and/or FIG. 4 herein.

The tender executor 320 includes a execute allocation module, a cancel transaction module, a amend module, a plan and execute allocation module, a store refunds module, an authorization module, a capture module, an exchange module, a refund module, an exchange cancel module, and a payment log module. The tender planner is configured to execute one or more of its modules based on communications with an order management system (OMS), an accounting system, a PGP, and an identification management system (IAM). In some embodiments, the tender planner 310 is configured to execute charge allocation in response to transaction requests. In some embodiments, the tender planner 310 is configured to perform one or more steps described with reference to FIG. 2 and FIG. 4 herein.

The payment processor 330 is configured to process split tender payments based on data received from the tender executor 320 and communications with the PGP and forward transaction information to a global information system (GIS), the OMS, and the accounting system. In some embodiments, the payment processor may store completed transactions in a transactions database.

Referring now to FIG. 4, a flow diagram of a process for determining split payment allocation recommendation is shown. In some embodiments, the steps shown in FIG. 4 may be performed by a processor-based device such as a control circuit executing a set of computer-readable instructions stored on a computer-readable memory. In some embodiments, one or more steps of FIG. 4 may be performed by the computer system 110 described with reference to FIG. 1, the charge allocation system 300 described with to FIG. 3 herein, or a similar device.

In step 401, the system calls the customer account (CA) database to obtain payment preferences of the customer, including expired cards and card verification value (CVV) identifiers. In step 402, the system determines if customer payment preference is present. If payment preference is not present in step 410, in step 412, the system responds with “no cards available.” If payment preference is present, in step 403, the system determines whether the customer has gift cards or directed spend (DS) cards. If so, in step 421, balances of the gift cards or DS cards are retrieved. In step 404, the system determines whether the customer has a DS card with a balance larger than zero. If so, in step 431, the system sends the content of a virtual basket and DS details to a promotion engine. In step 432, the system determines whether any item in the virtual basket can be covered by the DS card. If so, in step 433, the system allocates payment to the DS card based on the eligibility rules associated with the DS card. In step 434, the system determines whether the basket total has been covered. If so, the process proceeds to step 470.

If the system determines “no” in either step 403, step 404, step 432, or step 434, the process proceeds to step 405, and the system determines whether the customer has a benefits card such as an EBT card. In step 441, the system determines whether the customer has benefits program eligible items that are not covered by DS allocation. In step 442, the system allocates the cost of the items to the benefits card based on EBT eligibility rules. In step 443, the system determines whether the basket total has been covered. If so, the process proceeds to step 470.

If the system determines “no” in either step 405, step 441, or step 443, the process proceeds to step 406, and the system determines whether the customer has a gift card with a balance greater than zero. If so, in step 451, the system allocates the entire cost of the virtual basket or up to the gift card balance, whichever is lesser. In some embodiments, a gift card may have associated eligibility rules (e.g. cannot purchase another gift card), and the system may further allocate only gift card eligible items in step 451. In step 443, the system determines whether the basket total has been covered. If so, the process proceeds to step 470.

If the system determines “no” in either step 406 or step 452 (e.g. gift card balance insufficient or basket includes items not eligible for gift card payment), the process proceeds to step 407, and the system determines whether the customer has a credit card in the customer accounts database. If not, in step 408, the system outputs the allocated cards and the remaining amount owed. The customer may then choose to pay with a payment method not stored in the customer accounts database and/or by cash. If one or more credit or debit cards are present, the system allocates the remaining amount to the credit or debit card in step 461. In step 462, the system sends the allocation details to the checkout system, including any CVV information for payment processing. In step 470, the system outputs the complete allocation details including the allocated payment instruments and monetary amounts allocated to each payment instrument. In some embodiments, the allocation details may be displayed to a customer for review via a user interface. The user may then accept or modify the payment allocation to complete the purchase transaction.

Generally, the process shown in FIG. 4 takes into account-payment preferences of customers, the presence of gift cards, gift card balances, EBT cards, credit cards, etc. The process may output allocated card(s) with amount applied, remaining card balance, the leftover amount owed, a complete allocation of payments, or no cards available for payment to a user interface.

Referring now to FIGS. 5A-5C, a user interface for digital wallet payment is shown. In FIG. 5A, a customer may choose to add payment methods (e.g. gift card, credit/debit card, EBT, directed spend account). In FIG. 5B, when a customer is ready to check out, the system automatically displays a recommended allocation based on the available payment methods (e.g. EBT ending in 222, gift card ending in 333, etc.). In FIG. 5C, the customer scans a QR code to confirm the payment using split tenders.

Referring now to FIGS. 6A-6J, a user interface for a split tender transaction is shown. In FIG. 6A, a view of a customer's shopping cart is shown. In the cart, items eligible for select forms of tender may be marked (e.g. bananas and frozen berries are labeled “EBT eligible”). In FIG. 6B, in the initial checkout screen, the estimated total and the total for specific tender (e.g. “EBT food eligible $49.72”) may be displayed. In FIG. 6C, the customer may configure a delivery or pickup for the order. In FIG. 6D, the customer may initiate checkout and review/edit some order information. In FIG. 6E, the system shows a recommendation for split tender. In this case, the total amount is split between an EBT, two gift cards, and a VISA card. In some embodiments, the allocation may be determined based on the process shown in FIG. 2 and/or FIG. 4. The recommendation may be used as a default charge allocation if the customer selects to place the order on this screen. The customer may select “change payments” in FIG. 6E to configure the charge allocation in FIG. 6F. In FIG. 6F, available payment methods are displayed with each type of payment method (e.g. EBT, gift card, credit & debit card) shown in scrollable rows. One or more available payment methods may be selected or deselected through a checkbox to indicate whether the payment method should be used for the selected transaction. In FIG. 6F, EBT ending in 2222 is selected and gift cards ending in 3333 and 5678 are deselected. The VISA card, being the only available credit/debit card, in this case, cannot be deselected. In FIG. 6G, the customer may select an EBT and enter the EBT cash amount. The interface also allows the customer to view the EBT balance. In FIG. 6H, the customer may scroll up and down to view different payment method types and left and right on each row to see different payment instruments associated with each type. In FIG. 6I, the customer may add new payment instruments to the account including Medicare Advantage cards, FSA, EBT, gift cards, PayPal account, etc. FIG. 6J shows the adjusted split tender allocation after customer input (i.e. removing the gift cards and adding $5 of EBT cash) and the option to checkout with the updated allocation.

FIGS. 7A-7D comprises illustrations of a user interface for digital wallet payment. In FIG. 7A, a customer is instructed to scan a QR code associated with a POS terminal. In FIG. 7B, the customer may confirm payment and/or change payments. If the customer elects to change payment in FIG. 7B, in FIG. 7C, the customer may select or deselect individual payment instruments. FIG. 7D is a payment confirmation screen of a digital wallet transaction. A barcode associated with the payment receipt is included in the confirmation screen for payment verification and/or returns.

FIGS. 8A-8B comprises illustrations of user interfaces for digital wallet payment instrument management. FIG. 8A shows a desktop user interface that displays payment method types and individual payment instruments associated with each payment method types. The customer may add, modify, or remove payment instruments in this interface. In some embodiments, the customer may also set preferences or defaults for split tender charge allocation via the user interface. FIG. 8B shows a mobile user interface that allows the customer to manage payment instruments associated with their account. When the customer selects the digital wallet in the user interface, in FIG. 8C, the customer may edit, add, or remove payment methods via the user interface.

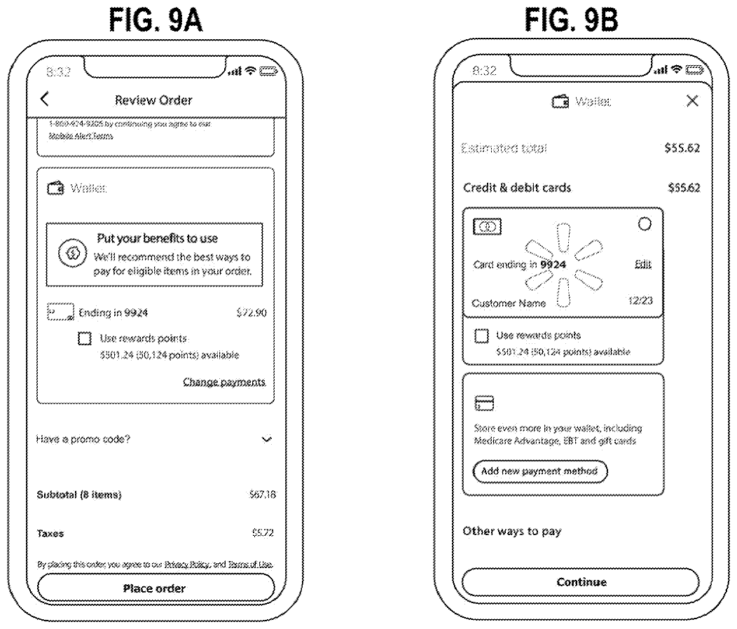

FIGS. 9A-9B comprises illustrations of user interfaces for digital wallet payment. In FIG. 9A, available reward points are shown with an option to “use reward points.” If the customer selects the reward points option, the total charged to the customer (single or split tender) is adjusted accordingly. In some embodiments, the customer may select the amount of points to apply in this user interface or the change payments interface. In some embodiments, the use of points may be included in the split tender allocation described herein. In FIG. 9B, available points associated with each payment instrument (e.g. credit card) may be displayed in the change payments interface. The customer may select/deselect an individual card and select to apply reward points from one or more of the cards in the interface to configure split tender allocation.

Table 1 comprises a table of example use cases in accordance with some embodiments. The table shows various allocation rules based on payment instrument availability and cart content. The rules are shown as example rules only. In some embodiments, customer preferences may be used to modify and/or override one or more of the rules. In some embodiments, a system may use a machine learning algorithm trained based on past customer purchase behavior to modify, remove, and/or generate new rules for allocation. In some embodiments, use cases assume basket eligibility for each payment method. Basket eligibility for each payment method may first be determined and then validated against the payment methods available in the customer's profile.

TABLE 1
Allocation Use Cases

| | CC | GC | DS | EBT | Use Cases | Allocation Rule |
|---|---|---|---|---|---|---|
| 1 | Y | | | | Only CC in profile | All funds get allocated to the CC |
| 2 | | Y | | | Only GC in profile which | All funds get allocated to GC |
| | | | | | can pay for all the | 10% mark up for weighted items, |
| | | | | | items (+10% mark up for | since GC is being used |
| | | | | | weighted items, bag | |
| | | | | | fees, delivery fees etc). | |
| 3 | | Y | | | Only GC in profile but it | Auto apply Gift Card but prompt |
| | | | | | has insufficient funds | customer to add another payment |
| | | | | | | method (CC) |
| | | | | | | 10% mark up for weighted items, |
| | | | | | | since GC is being used |
| 4 | | Y | | | Only GC in profile but | No Smart Allocation, since GC |
| | | | | | ineligible item | cannot be used in this case at all for |
| | | | | | | the transaction. Prompt customer to |
| | | | | | | add another payment method (CC) |
| | | | | | | 40% mark up since GC is not being |
| | | | | | | used |
| 5 | | Y | | | Multiple GCs in profile | Allocate first from the card with least |
| | | | | | which can pay for all the | amount of total funds |
| | | | | | items (+10% mark up for | |
| | | | | | weighted items, bag | |
| | | | | | fees, delivery fees etc). | |
| 6 | | | Y | | Only DS in profile which | All funds get allocated to DS |
| | | | | | can pay for all the | If any weighted item(s) is in the APL |
| | | | | | items (+10% mark up for | (Approved Products List) for DS card |
| | | | | | any weighted items, | being used for the transaction, include |
| | | | | | bag fees, applicable | a 10% markup. |
| | | | | | delivery fees) | |
| 7 | | | Y | | Only DS in profile but it | Auto apply DS but prompt customer |
| | | | | | has insufficient funds | to add another payment method (CC) |
| | | | | | | If any weighted item(s) is in the APL |
| | | | | | | (Approved Products List) for DS card |
| | | | | | | being used for the transaction, include |
| | | | | | | a 10% markup. |
| 8 | | | Y | | Only DS in profile but | Auto apply DS for eligible items but |
| | | | | | some ineligible item(s) | prompt customer to add another |
| | | | | | | payment method (CC) |
| | | | | | | If any weighted item(s) is in the APL |
| | | | | | | (Approved Products List) for DS card |
| | | | | | | being used for the transaction, include |
| | | | | | | a 10% markup. |
| 9 | | | Y | | Multiple DS cards | -Allocate first from the card with least |
| | | | | | (closed loop), same | amount of total funds |
| | | | | | program | |
| 10 | | | Y | | Multi-purse DS, multiple | Allocate eligible by PPC items to |
| | | | | | single purse cards | max balance on the DS card, then |
| | | | | | | EBT food, EBT cash, GC, then CC |
| | | | | | | Most restrictive PPC is the one that |
| | | | | | | can pay for the fewest items in the |
| | | | | | | basket |
| | | | | | | 1. Loop through all items and identify |
| | | | | | | list of eligible PPCs that can pay for |
| | | | | | | the item |
| | | | | | | 2. Sort list of items by count of |
| | | | | | | eligible PPC count in ascending order |
| | | | | | | (least likely to be paid for by DS Card |
| | | | | | | to most likely to be paid for by DS |
| | | | | | | Card) then by |
| | | | | | | 3. Sort list of PPCs by number of |
| | | | | | | items that can be paid for by the PPC |
| | | | | | | in ascending order (most restrictive |
| | | | | | | PPC to least restrictive PPC for items |
| | | | | | | in the basket) |
| | | | | | | 4. For each sorted item list |
| | | | | | | a. For each sorted PPCs |
| | | | | | | i. Allocate the item price to the PPC, |
| | | | | | | if eligible |
| | | | | | | Idea is to allocate by most restrictive |
| | | | | | | PPC for the basket rather than for the |
| | | | | | | universe of eligible products. |
| 11 | | | | Y | Only EBT in profile and | All funds get allocated to EBT Food, |
| | | | | | all eligible items in | EBT Cash is allocated $0 |
| | | | | | basket | We charge 10% extra for weighted |
| | | | | | | items and dont charge for bag fees |
| | | | | | | when |
| | | | | | | EBT is used |
| 12 | | | | Y | Only EBT in profile but | Auto apply EBT to the max value but |
| | | | | | it has insufficient funds | prompt customer to add another |
| | | | | | (customer validates the | payment |
| | | | | | balance through | method (CC) |
| | | | | | Acculynk) | We charge 10% extra for weighted |
| | | | | | | items and dont charge for bag fees |
| | | | | | | when |
| | | | | | | EBT is used |
| 13 | | | | Y | Only EBT in profile but | Auto apply EBT for eligible items but |
| | | | | | some ineligible item(s) | prompt customer to add another |
| | | | | | including delivery fees | payment |
| | | | | | etc | method (CC) |
| | | | | | | We charge 10% extra for weighted |
| | | | | | | items and dont charge for bag fees |
| | | | | | | when |
| | | | | | | EBT is used |
| 14 | Y | Y | | | CC and GC(s) in profile | Allocate funds first to gift cards and |
| | | | | | (no ineligible items for | then to CC |
| | | | | | GC) | 10% mark up for weighted items, |
| | | | | | | since GC is being used |
| 15 | Y | Y | | | CC and GC(s) in profile | Allocate funds to CC only (Gift Card |
| | | | | | (at least one ineligible | cannot be applied to the transaction) |
| | | | | | item for GC) | 40% mark up for weighted items, |
| | | | | | | since GC is not being used |
| 16 | Y | | Y | | CC and DS(s) in profile | Allocate funds first to DS based on |
| | | | | | | the DS allocation logic and then to |
| | | | | | | CC |
| | | | | | | If any weighted item(s) is in the APL |
| | | | | | | (Approved Products List) for DS card |
| | | | | | | being |
| | | | | | | used for the transaction, include a |
| | | | | | | 10% markup else add 40% markup |

In one embodiment, a system for automatic charge allocation is provided. The system comprises a payment rules database storing eligibility rules associated with a plurality of payment method types, a product database storing product characteristics associated with a plurality of products, a customer database, a network interface configured to receive data from a user device, and a control circuit coupled to the payment rules database, the product database, the customer database, and the network interface. The control circuit being configured to retrieve a plurality of payment instruments associated with a customer account from the customer database, wherein the plurality of payment instruments includes payment instruments of two or more payment method types, retrieve eligibility rules associated with each of the plurality of payment instruments from the payment rules database, receive, via the network interface, a list of products for purchase, determine an allocation order for the plurality of payment instruments, determine a charge allocation between the plurality of payment instruments based on the allocation order, eligibility rules associated with each of the plurality of payment instruments, and characteristics of products in the list of products for purchase retrieved from the product database, cause, via the network interface, the charge allocation to be displayed via a user payment user interface on the user device, and process a transaction for the list of products using two or more of the plurality of payment instruments based on the charge allocation.

In one embodiment, a method for automatic charge allocation comprises retrieving, at a control circuit, a plurality of payment instruments associated with a customer account from a customer database, wherein the plurality of payment instruments includes payment instruments of two or more payment method types, retrieving, at the control circuit, eligibility rules associated with each of the plurality of payment instruments from a payment rules database storing eligibility rules associated with a plurality of payment methods, determining, with the control circuit, an allocation order for the plurality of payment instruments, determining, with the control circuit, a charge allocation between the plurality of payment instruments based on the allocation order, the eligibility rules associated with each of the plurality of payment instruments, and characteristics of products in the list of products for purchase retrieved from a product database, receiving, from a user device and via a network interface coupled to the control circuit, a list of products for purchase, causing, via the network interface, the charge allocation to be displayed via a user payment user interface on the user device, and processing a transaction for the list of products using two or more of the plurality of payment instruments based on the charge allocation.

In one embodiment, an apparatus for automatic charge allocation comprises a non-transitory storage medium storing a set of computer readable instructions and a control circuit configured to execute the set of computer readable instructions which cause to the control circuit to retrieve a plurality of payment instruments associated with a customer account from a customer database, wherein the plurality of payment instruments includes payment instruments of two or more payment method types, retrieve eligibility rules associated with each of the plurality of payment instruments from a payment rules database storing eligibility rules associated with a plurality of payment methods, receive, from a user device and via a network interface, a list of products for purchase, determine an allocation order for the plurality of payment instruments, determine, with the control circuit, a charge allocation between the plurality of payment instruments based on the allocation order, eligibility rules associated with each of the plurality of payment instruments, and characteristics of products in the list of products for purchase retrieved from a product database, cause, via the network interface, the charge allocation to be displayed via a user payment user interface on the user device, and process a transaction for the list of products using two or more of the plurality of payment instruments based on the charge allocation.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. A system for automatic charge allocation, the system comprises:
a payment rules database storing eligibility rules associated with a plurality of payment method types;
a product database storing product characteristics associated with a plurality of products;
a customer database;
a network interface configured to receive data from a user device; and
a control circuit coupled to the payment rules database, the product database, the customer database, and the network interface, the control circuit being configured to:
retrieve a plurality of payment instruments associated with a customer account from the customer database, wherein the plurality of payment instruments includes payment instruments of two or more payment method types;
retrieve eligibility rules associated with each of the plurality of payment instruments from the payment rules database;
receive, via the network interface, a list of products for purchase;
determine an allocation order for the plurality of payment instruments;
determine a charge allocation between the plurality of payment instruments based on the allocation order, eligibility rules associated with each of the plurality of payment instruments, and characteristics of products in the list of products for purchase retrieved from the product database;
cause, via the network interface, the charge allocation to be displayed via a user payment user interface on the user device; and
process a transaction for the list of products using two or more of the plurality of payment instruments based on the charge allocation.

2. The system of claim 1, wherein determining the charge allocation comprises:
for each product in the list of products for purchase,
determine whether the product is eligible for payment by a first payment instrument according to the allocation order of the plurality of payment instruments based on the eligibility rules associated with the first payment instrument stored in the payment rules database and product information stored in the product database; and
in the event that the product is not eligible for payment by the first payment instrument, determine whether the product is eligible for payment by a second payment instrument in the allocation order of the plurality of payment instruments based on the eligibility rules associated with the second payment instrument stored in the payment rules database and the product information.

3. The system of claim 2, wherein
in the event that the product is eligible for payment using the first payment instrument, determine whether sufficient fund is present in the first payment instrument to pay for the product; and
in the event that sufficient fund is not present in the first payment instrument, determine whether the product is eligible for payment by the second payment instrument in the allocation order of the plurality of payment instruments.

4. The system of claim 1, further comprising:
displaying the plurality of payment instruments in the user payment user interface;
receiving a user selection of a subset of the plurality of payment instruments in response to displaying the charge allocation;
determine an updated charge allocation based on the subset of the plurality of payment instruments; and
cause the updated charge allocation to be displayed on the user payment user interface.

5. The system of claim 1, wherein the allocation order is determined based on payment method types associated with each of the plurality of payment instruments.

6. The system of claim 5, wherein in the event that multiple payment instruments are of a same payment method type, the allocation order of the multiple payment instruments is determined based on maximizing a total payment allocated to all payment instruments of the payment method type.

7. The system of claim 1, wherein the plurality of payment instruments includes an unrestrictive payment instrument, and the charge allocation is further determined to minimize an amount allocated to the unrestrictive payment instrument.

8. The system of claim 1, wherein the two or more payment method types comprises two or more of: credit or debit cards, gift cards, benefits cards, directed spend cards, or rewards points.

9. The system of claim 1, wherein the eligibility rules comprise one or more of included products, included product categories, included product characteristics, excluded products, excluded product categories, and excluded product characteristics.

10. The system of claim 1, wherein two or more different payment instruments associated with a payment method type has different eligibility rules.

11. A method for automatic charge allocation, the method comprises:
retrieving, at a control circuit, a plurality of payment instruments associated with a customer account from a customer database, wherein the plurality of payment instruments includes payment instruments of two or more payment method types;
retrieving, at the control circuit, eligibility rules associated with each of the plurality of payment instruments from a payment rules database storing eligibility rules associated with a plurality of payment methods;
determining, with the control circuit, an allocation order for the plurality of payment instruments;
determining, with the control circuit, a charge allocation between the plurality of payment instruments based on the allocation order, the eligibility rules associated with each of the plurality of payment instruments, and characteristics of products in the list of products for purchase retrieved from a product database;
receiving, from a user device and via a network interface coupled to the control circuit, a list of products for purchase;
causing, via the network interface, the charge allocation to be displayed via a user payment user interface on the user device; and
processing a transaction for the list of products using two or more of the plurality of payment instruments based on the charge allocation.

12. The method of claim 11, wherein determining the charge allocation comprises:
for each product in the list of products for purchase,
determine whether the product is eligible for payment by a first payment instrument according to the allocation order of the plurality of payment instruments based on the eligibility rules associated with the first payment instrument stored in the payment rules database and product information stored in the product database; and
in the event that the product is not eligible for payment by the first payment instrument, determine whether the product is eligible for payment by a second payment instrument in the allocation order of the plurality of payment instruments based on the eligibility rules associated with the second payment instrument stored in the payment rules database and the product information.

13. The method of claim 12, further comprising:
in the event that the product is eligible for payment using the first payment instrument, determining whether sufficient fund is present in the first payment instrument to pay for the product; and
in the event that sufficient fund is not present in the first payment instrument, determining whether the product is eligible for payment by the second payment instrument in the allocation order of the plurality of payment instruments.

14. The method of claim 11, further comprising:
displaying the plurality of payment instruments in the user payment user interface;
receiving a user selection of a subset of the plurality of payment instruments in response to displaying the charge allocation;
determining an updated charge allocation based on the subset of the plurality of payment instruments; and
causing the updated charge allocation to be displayed on the user payment user interface.

15. The method of claim 11, wherein the allocation order is determined based on payment method types associated with each of the plurality of payment instruments.

16. The method of claim 15, wherein in the event that multiple payment instruments are of a same payment method type, the allocation order of the multiple payment instruments is determined based on maximizing a total payment allocated to all payment instruments of the payment method type.

17. The method of claim 11, wherein the plurality of payment instruments includes an unrestrictive payment instrument, and the charge allocation is further determined to minimize an amount allocated to the unrestrictive payment instrument.

18. The method of claim 11, wherein the two or more payment method types comprises two or more of: credit or debit cards, gift cards, benefits cards, directed spend cards, or rewards points.

19. The method of claim 11, wherein the eligibility rules comprise one or more of included products, included product categories, included product characteristics, excluded products, excluded product categories, and excluded product characteristics.

20. An apparatus for automatic charge allocation comprising:
a non-transitory storage medium storing a set of computer-readable instructions; and
a control circuit configured to execute the set of computer-readable instructions which cause the control circuit to:
retrieve a plurality of payment instruments associated with a customer account from a customer database, wherein the plurality of payment instruments includes payment instruments of two or more payment method types;
retrieve eligibility rules associated with each of the plurality of payment instruments from a payment rules database storing eligibility rules associated with a plurality of payment methods;
receive, from a user device and via a network interface, a list of products for purchase;
determine an allocation order for the plurality of payment instruments;
determine, with the control circuit, a charge allocation between the plurality of payment instruments based on the allocation order, eligibility rules associated with each of the plurality of payment instruments, and characteristics of products in the list of products for purchase retrieved from a product database;
cause, via the network interface, the charge allocation to be displayed via a user payment user interface on the user device; and
process a transaction for the list of products using two or more of the plurality of payment instruments based on the charge allocation.
